(19) United States
(12) Patent Application Publication
(10) Pub. No.: US 2025/0056243 A1
(43) Pub. Date: Feb. 13, 2025

(54) Locating Mobile Local Area Network Transceivers For Use By Multiple Network-Connected Computers

(71) Applicant: INTERNATIONAL BUSINESS MACHINES CORPORATION, ARMONK, NY (US)

(72) Inventors: Zachary A. Silverstein, Georgetown, TX (US); Logan Bailey, Atlanta, GA (US); Jaclyn Rudolf, Bellmore, NY (US); Taylor Segell, Atlanta, GA (US)

(21) Appl. No.: 18/447,628

(22) Filed: Aug. 10, 2023

(51) Int. Cl. H04W 16/22

(52) U.S. Cl. CPC H04W 16/22; H04W 84/12

(57) ABSTRACT

Creating or refining a computer implemented map of signal strength of a local area network (“LAN”) using an autonomous vehicle equipped with a network signal strength sensor (for example, a Wi-Fi transceiver that includes RSSI (“Received Signal Strength Indicator”) hardware). The autonomous vehicle travels around the geographical area of interest (for example, a building) and measures signal strength of a predetermined LAN at various points in the geographical area to determine, and dynamically re-determine, a zone where LAN signal strength is greater than a predetermined value. The network map may be used as a basis for adjusting LAN operating parameters to ensure network coverage/signal stability where it is needed and/or expected.

### BACKGROUND

The present invention relates generally to the field of wireless site surveys and wireless local area network transceivers, such as Wi-Fi (sometimes herein “Wi-Fi”) modem/routers and mesh network repeater hardware for wireless local area networks.

The Wikipedia entry for “Wi-Fi” (as of 12 Feb. 2023) states, in part, as follows: “Wi-Fi . . . is a family of wireless network protocols based on the IEEE 802.11 family of standards, which are commonly used for local area networking of devices and Internet access, allowing nearby digital devices to exchange data by radio waves. These are the most widely used computer networks in the world, used globally in home and small office networks to link desktop and laptop computers, tablet computers, smartphones, smart TVs, printers, and smart speakers together and to a wireless router to connect them to the Internet, and in wireless access points in public places like coffee shops, hotels, libraries, and airports to provide visitors with Internet connectivity for their mobile devices.” (footnotes omitted)

The Wikipedia entry for “wireless site surveys” (as of 12 Feb. 2023) states, in part, as follows: “A wireless site survey, sometimes called an RF (Radio Frequency) site survey or wireless survey, is the process of planning and designing a wireless network, to provide a wireless solution that will deliver the required wireless coverage, data rates, network capacity, roaming capability and quality of service (QoS). The survey usually involves a site visit to test for RF interference, and to identify optimum installation locations for access points. This requires analysis of building floor plans, inspection of the facility, and use of site survey tools. Interviews with IT management and the end users of the wireless network are also important to determine the design parameters for the wireless network. As part of the wireless site survey, the effective range boundary is set, which defines the area over which signal levels needed support the intended application. This involves determining the minimum signal-to-noise ratio (SNR) needed to support performance requirements . . . . There are three main types of wireless site surveys: passive, active, and predictive . . . . Additionally, some survey application[s] allow the user to collect RF spectrum data using portable hardware spectrum analyzers, which is beneficial in case of high RF interference from non-802.11 sources, such as microwave ovens or cordless phones . . . . Passive and active surveys are performed using software and typically require only a compatible off-the-shelf Wi-Fi adapter; no additional specialized hardware is required . . . . Unlike passive and active surveys, RF spectrum surveys require specialized RF equipment. There are various types of spectrum analyzers ranging from large and expensive bench-top units to portable (“field units”) and PC-based analyzers. Because portability is a decisive factor in conducting wireless site surveys, PC-based spectrum analyzers in CardBus and USB form factors are widely used today. WLAN chipset manufacturers are starting to incorporate spectrum analysis into their chipset designs; this functionality is integrated into some high-end enterprise-class 802.11n access points.” (footnotes omitted)

Boundaries within an IOT (Internet of Things) network may not be consistent based on environmental factors and external changes. Variation in the network range or bands of signal strength may affect how some devices interact within this network. Modeling precise range metrics and bounds may be difficult within a network with unpredictable environmental factors.

U.S. Pat. No. 11,031,996 (“Nilsson”) states as follows (reference numbers refer to the Figures of Nilsson which are not reproduced in this document): “the personal UAV repeater 1 is configured to, after the user has sent up the personal UAV repeater in the air: increase its height while it continuously measures received signal strength from the surrounding base stations 3 or other types of access points, upon the received signal power exceeding a certain threshold, the personal UAV repeater 1 stops increasing its height, and convey signaling between the communication device and the base station 3 . . . the method 10 may comprise having the unmanned aerial vehicle 1 rising continuously while simultaneously rotating and measuring the signal strength. When the measured signal strength is determined to have reached the threshold value, which may be set such as to ensure signal strength to be sufficient, the unmanned aerial vehicle may come to a standstill. The features of the embodiments may be combined in many ways, providing various new embodiments e.g. combining the altitude changes and the rotation around a vertical axis in different ways such as to find a height and direction for receiving a sufficiently high signal power from the entity 3, 4 of the wireless communications system for conveyance to the first communication device 2, and also in the reverse direction from the first communication device 2 to the network entity 3.”

### SUMMARY

According to an aspect of the present invention, there is a method, computer program product and/or system that performs the following operations (not necessarily in the following order): (i) providing an autonomous vehicle equipped with a signal strength detector structured and configured to detect signal strength of a first local area network (“LAN”) located in a first geographic area; (ii) traversing, by the autonomous vehicle, at least a portion of the first geographic area; (iii) during the traversing, detecting signal strength of the first LAN to create a set of network map inputs; and (iv) creating or refining a network map that maps a plurality of portions of the first geographic area respectively to signal strength of the first LAN based on the network map inputs.

### BRIEF DESCRIPTION OF THE DRAWINGS

FIGS. 1A, 1B and 1C, taken together, form a block diagram of a first embodiment of a system (sometimes called “LAN environment” or “network environment”) according to the present invention;

FIG. 2 is a block diagram showing a machine logic (for example, software) portion of the first embodiment system;

FIG. 3 is a flowchart showing a first embodiment method performed, at least in part, by the first embodiment system;

FIG. 4 is a flowchart showing a second embodiment method.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

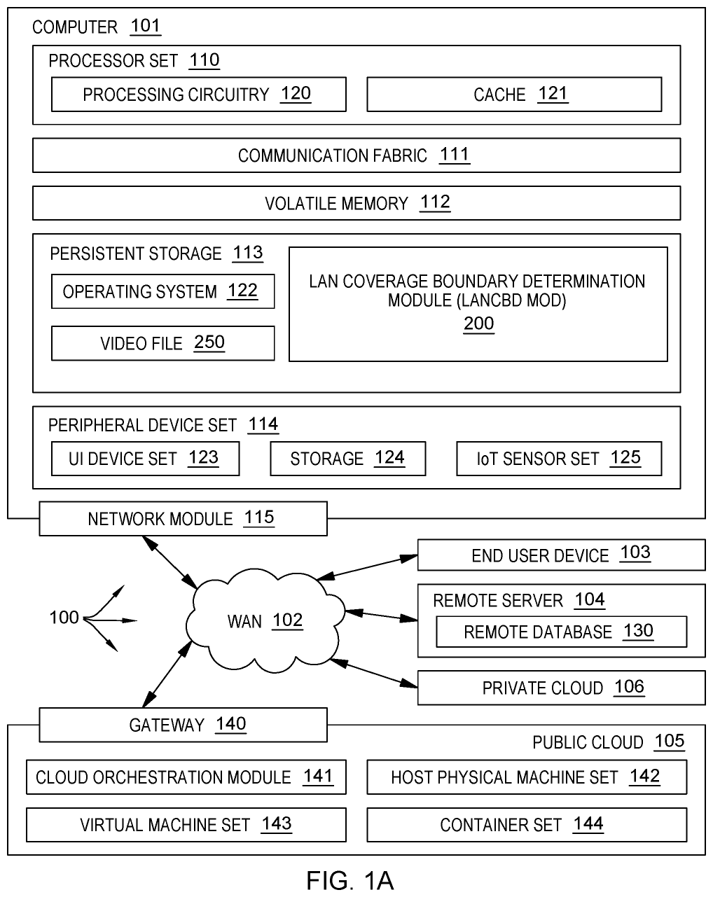

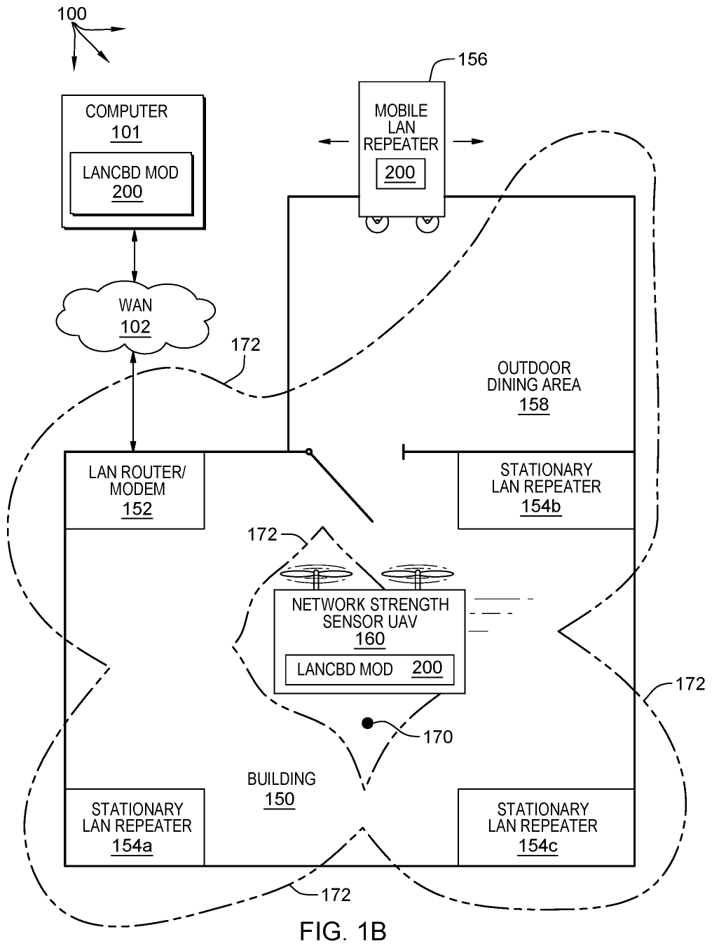

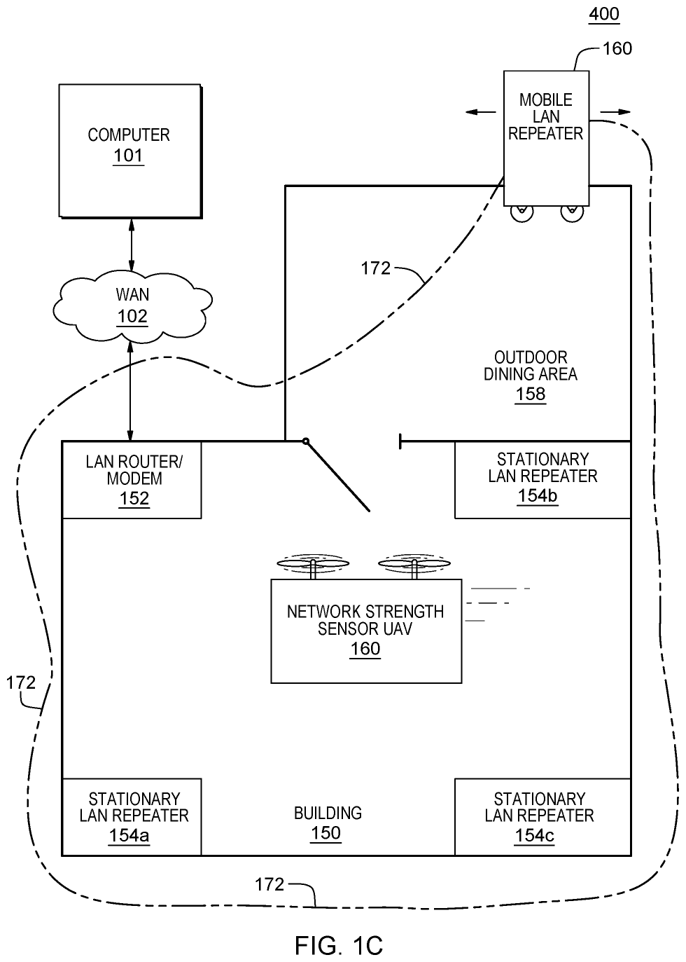

As shown in FIGS. 1A and 1B, LAN environment 100 (and also the positionally adjusted version 400 of LAN environment 100) contains an example of an environment for the execution of at least some of the computer code involved in performing the inventive methods, such as LAN coverage boundary determination module (LANCBD mod) 200 (also herein sometimes referred to as block 200). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, container set 144, building 150, LAN router/modem 152, stationary LAN repeaters 154a,b,c, mobile LAN repeater 156, outdoor dining area 158, network strength sensor UAV 160, LAN coverage dead zone 170, and LAN coverage zone boundary 172.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods. Various other kinds of files can be stored in the persistent storage such as video file 250.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### II. Example Embodiment

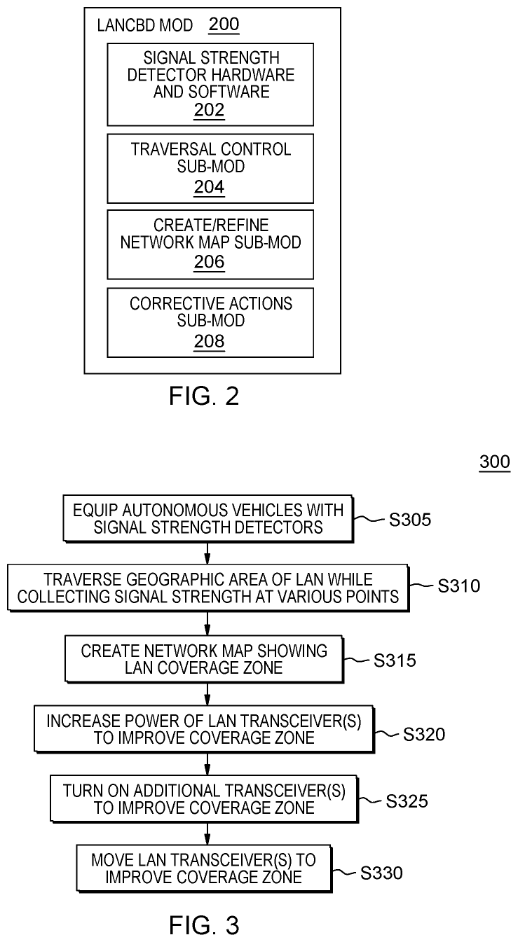

LAN environment 100 is an environment in which an example method according to the present invention can be performed. As shown in FIG. 3, flowchart 300 shows an example method according to the present invention. As shown in FIG. 2, LANCBD mod 200 performs or controls performance of at least some of the method operations of flowchart 300. This method and associated software will now be discussed, over the course of the following paragraphs, with extensive reference to the blocks of FIGS. 1B, 1C, 2 and 3.

OPERATION S305: Autonomous vehicles mobile LAN repeater 156 and network strength sensor unmanned aerial vehicle (UAV) 160 are each equipped with LANCBD mod 200, which includes signal strength detector hardware and software 202. Signal strength detector hardware and software 202 is structured and configured to detect signal strength of a first local area network (“LAN”) located in a first geographic area. In this example, the LAN is a Wi-Fi type LAN that is implemented by various LAN transceivers 152, 154a,b,c and 156. These LAN transceivers provide Wi-Fi service to building 150 and outdoor dining area 158 and can connect end user devices (not separately shown) through the Wi-Fi LAN to the internet (that is WAN 102). As shown In FIG. 1B, at the time of operation S305, Wi-Fi coverage zone 172 has a dead spot 170 at the center of building 150. Also, mobile LAN repeater 156 is temporarily not acting as a repeater so that it can temporarily be used as an autonomous vehicle that scans network strength at various points along its track (not separately shown) running along the outer edge of outdoor dining area 158. In this example, the building and ground are level and signal strength does not vary much with small changes in height or elevation. This means that this is a 2D LAN with a 2D network map. Alternatively, other embodiments may employ a three dimension LAN coverage map that accounts for changes in elevation (for example, a LAN covering a multi-story building.

OPERATION S310: Under control of traversal control sub-mod 204, autonomous vehicles 156, 160 traverse the geographic area of the LAN, and, during the traversing, detect signal strength of the first LAN to create a set of network map inputs. In this example, mobile LAN repeater 156 is an autonomous wheeled vehicle that travels over the ground on a linear track. The main purpose of repeater 156 is to cover the outdoor dining area with LAN sufficient signal for steady connections (at least −50 dBm radio signal power in this example). However, in order to do that, it must be able to receive a strong and steady signal from one of the other LAN transceivers 152, 154a,b,c. As shown in FIG. 1B, repeater 156 is outside of the network coverage zone 156. UAV 160 is free to fly throughout the entire geographic area, except where constrained by building walls and the like. As shown in FIG. 1B, UAV 160 is just flying due west into the center of dead zone 170 in network coverage zone 172. Unlike repeater 156, UAV 160 is not part of the hardware implementing the LAN and is used only for determining zones of various coverage strength. In this example, there are only two domains of network coverage as follows: (i) points with signal strength less than −50 dBm considered to be outside the coverage zone; and (ii) points with signal strength greater than −50 dBm considered to be in the zone of acceptable LAN signal coverage. Alternatively, the network map can be more granular with respect to coverage zones (for example, excellent coverage zone, good coverage zone, fair coverage zone, no-coverage zone). The network map of LAN coverage may include additional metrics such as how steady/jittery the LAN signal is over time. This example measures signal strength in absolute terms using units of power (dBm). Alternatively, a relative scale may be used, such as RSSI scales developed by hardware manufacturers and in common use.

OPERATION S315: create/refine network map sub-mod 206 create or refine a network map that maps a plurality of portions of the first geographic area respectively to signal strength of the first LAN based on the network map inputs previously obtained at Operation S310. A visual representation of a network map (only 2D in this example) is shown in FIGS. 1B and 1C by the superimposition of network boundary lines 170, 172 over the background geographic features, like building 150 and outdoor dining area 158. At the time of FIG. 1B, the network coverage of LAN transceivers 152, 154a,b,c suffers from the following issues: (i) dead spot 170 at the center of building 150; and (ii) sufficient LAN signal coverage (more then −50 dBm in this example) does not reach mobile LAN repeater 160 in its current position along its track (meaning that outdoor dining area 158 is not fully covered). With respect to the dead spot issue, at the previous operation, UAV 160 traversed into the dead spot and detected the insufficient LAN signal strength there—this is how the bounds demarcating dead spot 170 were determined. With respect to the failure to cover mobile LAN repeater 160, mobile LAN repeater was controlled by sub-mod 204 to do its own traversal along a traversal path defined by its track—this is how the coverage zone bounds at the outermost edge of the outdoor dining area were determined for the network map as shown in FIG. 1B.

OPERATION S320: corrective actions sub-mod 208 of LANCBD mod 200 of UAV 160 instructs stationary LAN repeaters 154b,c to increase their transmission power by 25% each in response to the detection and mapping of dead spot 170. By comparing FIG. 1B with FIG. 1C, it can be seen that this power increase of these LAN transceivers eliminates dead spot 170.

OPERATION S325: corrective actions sub-mod 208 of LANCBD mod 200 of mobile LAN repeater 160 powers up its LAN transceiver hardware so that outdoor dining area 158 gets sufficient LAN signal coverage. Because the network map bounds developed by repeater 160 at Operations S310 and S315 show that there is a position where repeater 160 can communicate with the other LAN transceiver(s), it makes sense for it to power up its LAN extension capabilities.

OPERATION S330: corrective actions sub-mod 208 of LANCBD mod 200 of mobile LAN repeater 160 instructs the mobile LAN repeater to move to a position along its track where it is covered in the LAN coverage zone (as shown in FIG. 1C). This is an example of moving LAN hardware according to a LAN coverage zone map.

In the above example, the network signal strength was measured directly, which is to say that signal strength was directly measured by the detector hardware of the autonomous vehicles, and these direct measurements could be used to generate network coverage zone bounds on network maps. Alternatively, or additionally, these measurements may be made indirectly by measuring a rates of change in measured LAN signal strength between consecutive measurement points. For example, if Wi-Fi signal power drops from −X dBm to −2X dBm over the course of 1 meter along a vehicle's traversal vector, then the rate of change is −X dBm per meter. These rates of change can be used to project where network bounds are occurring even if the autonomous vehicle doesn't travel (for example, physically blocked) through the bound itself and does not take direct measurements in the vicinity of the projected boundary.

### III. Further Comments and/or Embodiments

PROBLEM: Find a computer implemented technique to precisely model network metrics within an IoT (“Internet of Things”) network by utilizing real time data received by an in-network device so that computers (for example, laptops, smart phones, etc.) can receive better reception when communicating through a Local Area Network (for example, communicating through a Wi-Fi modem/router to the internet (a Wide Area Network).

SOLUTION: A computer implemented system and method that derives a network bounds and metrics model from a received signal strength indicator delta relative to IoT device movement within the network geography and environment. Also, movement of LAN equipment (for example, a Wi-Fi repeater device that is part of the hardware of a LAN) by remote controlled vehicles (for example, unmanned aerial vehicles) to optimize signal strength over a set of computers present in the local area covered by the LAN equipment.

In some embodiments, a computational module determines network range bounds and metrics in three dimensional space (herein sometimes referred to as a “LAN environment”) based on a received signal strength indicator delta relative to IOT device position and/or movement. Consider, for example, a UAV traveling toward the bounds of a network, the module can detect the change in RSSI (“Received Signal Strength Indicator”) relative to distance and environmental factors to predict geographical and spatial bounds. In some embodiments, predicted network range spatial bounds alter IOT device behavior. In some embodiments, a UAV alters its flight path to avoid crossing predicted range bounds to avoid loss of signal. In some embodiments, environmental variable factors are measured relative to RSSI delta across various velocities and spatial locations to improve predictive capabilities. In some embodiments, the discovery of device in network approaching signal bounds automates generation or modification of an ad hoc mesh network to extend bounds and preserve connection. In some embodiments, the module may emulate or physically carry hardware to capture device specific range metrics.

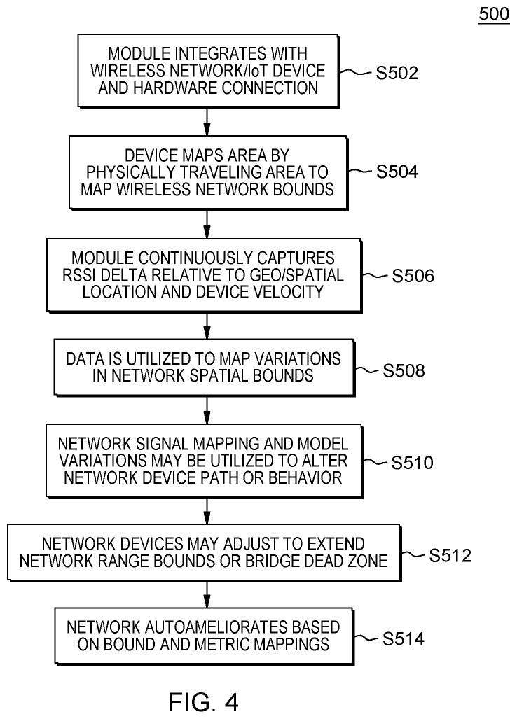

Flow chart 500 of FIG. 4 shows a method of adjusting a LAN coverage zone. The seven operations of the method of flowchart 500 will be respectively discussed in the following seven (7) paragraphs.

OPERATION S502: an autonomous vehicle is equipped with a LAN signal strength detector and appropriate software for performing the method.

OERATION S504: the autonomous vehicle traverses a geographic area while measuring the LAN signal strength at various points. A first version of a network coverage map for the LAN is thereby obtained.

OPERATION S506: Autonomous vehicle tracks the rate of change of signal strength with respect to distance along a traversal path.

OPERATION S508: The rate of signal strength change over direction/distance of the traversal path determined at the previous operation is used to refine network boundaries of the network coverage map on a dynamic basis.

OPERATION S510: Network coverage map is used to drive change operating parameter(s) of the LAN, such as by turning on additional LAN transceivers, increasing power of LAN transceivers, changing angular orientation of LAN transceivers and/or changing location of LAN transceiver(s).

OPERATION S512: In this example, the adjustments made at the previous operation serve to extend network bounds (for example, network coverage zone where signal strength is greater than −50 dBm) and also to bridge a dead zone.

OPERATION S514: LAN auto-ameliorates based on network coverage map of signal strength and other LAN signal metrics.

A method according to the present invention includes the following operations: (i) user opts into invention module and provides wireless access and IOT device and hardware connection; (ii) the IOT UAV will take initial steps in mapping the area by physically travelling to the extents of the wireless network as detected by the UAV itself; (iii) the UAV may take mapping images of the ground underneath it to associate a physical area representation with signal strength; (iv) the UAV captures the strength and degradation of the signal from the source to the last available area for robust wireless connectivity; (v) the module iteratively and continuously captures RSSI delta relative to its geographic/spatial location and velocity to map variations in network range bounds and metrics (in some embodiments, a device with greater mobile/spatial mobility may be utilized to emulated hardware connectivity of other devices within the network); (vi) the UAV may pick up or hold a device and map each connectivity based on hardware or network version of wireless connectivity software and drivers; (vii) network signal mappings and models generated by data stream may be utilized by devices within the network to alter path or behavior to retain network connection (for example, automated delivery UAVs connected to the network may alter or limit path based on projected signal metric bounds, an IOT wearable may alter behavior based on expected bandwidth variations or loss of connection); (viii) IOT device detection of movement toward network bounds or dead zone, may signal to generate ad-hoc mesh network to extend network or bridge dead zone connection; (ix) an automated delivery done detects other UAV in network navigating towards range bounds or dead zone, and moves to extend network bounds within a mesh network; and (x) iteratively based on detection of changed physical space under the UAV (using camera) or based on time, the UAV will re-map and restart the process over to continue gauging with a high degree of accuracy.

A system/method, according to an aspect of the present invention, dynamically adjusts a network boundary based on a signal strength indicator delta by performing the following operations: (i) mapping, by one or more movable IoT devices, a three-dimensional network boundary based on signal strength and/or RSSI delta at the various locations; (ii) generating a visual representation of the network boundary; (iii) dynamically adjusting the location of network devices configured to strengthen and/or weaken the network strength in various location, wherein the adjusting includes moving a network device toward/away from the location, and the movement is configured to adjust the range or bridge a network dead zone; and (iv) updating, based on the adjustments, the mapping of the network boundary.

Some additional operations performed in some embodiments and/or features of some embodiments are as follows: (i) the IoT devices and the network devices are each attached to a UAV, and the three-dimensional network boundary can include geographic representations of the terrain; (ii) the bridging the dead zone includes generating a mesh network with two or more network devices; (iii) mapping and continuously monitoring network spatial bounds based on a pre-existing network to map out accessibility; and/or (iv) autonomous vehicle(s) used physically map and visually display spatial bounds to the user.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Set of thing(s): does not include the null set; “set of thing(s)” means that there exist at least one of the thing, and possibly more; for example, a set of computer(s) means at least one computer and possibly more.

What is claimed is:

1. A computer-implemented method (CIM) comprising:
providing an autonomous vehicle equipped with a signal strength detector structured and configured to detect signal strength of a first local area network (“LAN”) located in a first geographic area;
traversing, by the autonomous vehicle, at least a portion of the first geographic area;
during the traversing, detecting signal strength of the first LAN to create a set of network map inputs; and
creating or refining a network map that maps a plurality of portions of the first geographic area respectively to signal strength of the first LAN based on the network map inputs.

2. The CIM of claim 1 wherein the network map includes an indication of a first LAN coverage zone where the signal strength of the first LAN exceeds a predetermined threshold.

3. The CIM of claim 2 further comprising:
determining a corrective action based on the indication of the first LAN coverage zone, with the corrective action being at least one of the following: increase first LAN power, turn on additional LAN transceiver(s) and/or move one or more LAN transceiver(s).

4. The CIM of claim 1 wherein:
the autonomous vehicle is an unmanned aerial vehicle (“UAV”);
the traversing by the autonomous vehicle includes substantial motion in all three spatial directions; and
the network map is three dimensional.

5. The CIM of claim 1 wherein:
the first LAN is a Wi-Fi type LAN; and
the signal strength detector measures a power of radio waves received at a predetermined operating frequency of the first LAN.

6. The CIM of claim 1 wherein the creating or refining of the network map includes:
determination of signal strength at various points along a traversal path of the autonomous vehicle; and
determination of a portion of a network boundary based upon rate of change in signal strength along the traversal path.

7. A computer program product (CPP) comprising:
a set of storage device(s); and
computer code stored collectively in the set of storage device(s), with the computer code including data and instructions to cause a processor(s) set to perform at least the following operations:
providing an autonomous vehicle equipped with a signal strength detector structured and configured to detect signal strength of a first local area network (“LAN”) located in a first geographic area,
traversing, by the autonomous vehicle, at least a portion of the first geographic area;
during the traversing, detecting signal strength of the first LAN to create a set of network map inputs, and
creating or refining a network map that maps a plurality of portions of the first geographic area respectively to signal strength of the first LAN based on the network map inputs.

8. The CPP of claim 7 wherein the network map includes an indication of a first LAN coverage zone where the signal strength of the first LAN exceeds a predetermined threshold.

9. The CPP of claim 8 wherein the computer code further includes data and instructions to cause the processor(s) set to perform at least the following operations:
determining a corrective action based on the indication of the first LAN coverage zone, with the corrective action being at least one of the following: increase first LAN power, turn on additional LAN transceiver(s) and/or move one or more LAN transceiver(s).

10. The CPP of claim 7 wherein:
the autonomous vehicle is an unmanned aerial vehicle (“UAV”);
the traversing by the autonomous vehicle includes substantial motion in all three spatial directions; and
the network map is three dimensional.

11. The CPP of claim 7 wherein:
the first LAN is a Wi-Fi type LAN; and
the signal strength detector measures a power of radio waves received at a predetermined operating frequency of the first LAN.

12. The CPP of claim 7 wherein the creating or refining of the network map includes:
determination of signal strength at various points along a traversal path of the autonomous vehicle; and
determination of a portion of a network boundary based upon rate of change in signal strength along the traversal path.

13. A computer system (CS) comprising:
a processor(s) set;
a set of storage device(s); and
computer code stored collectively in the set of storage device(s), with the computer code including data and instructions to cause the processor(s) set to perform at least the following operations:
providing an autonomous vehicle equipped with a signal strength detector structured and configured to detect signal strength of a first local area network (“LAN”) located in a first geographic area,
traversing, by the autonomous vehicle, at least a portion of the first geographic area;
during the traversing, detecting signal strength of the first LAN to create a set of network map inputs, and
creating or refining a network map that maps a plurality of portions of the first geographic area respectively to signal strength of the first LAN based on the network map inputs.

14. The CS of claim 13 wherein the network map includes an indication of a first LAN coverage zone where the signal strength of the first LAN exceeds a predetermined threshold.

15. The CS of claim 14 wherein the computer code further includes data and instructions to cause the processor(s) set to perform at least the following operations:
determining a corrective action based on the indication of the first LAN coverage zone, with the corrective action being at least one of the following: increase first LAN power, turn on additional LAN transceiver(s) and/or move one or more LAN transceiver(s).

16. The CS of claim 13 wherein:
the autonomous vehicle is an unmanned aerial vehicle (“UAV”);
the traversing by the autonomous vehicle includes substantial motion in all three spatial directions; and
the network map is three dimensional.

17. The CS of claim 13 wherein:
the first LAN is a Wi-Fi type LAN; and
the signal strength detector measures a power of radio waves received at a predetermined operating frequency of the first LAN.

18. The CS of claim 13 wherein the creating or refining of the network map includes:
determination of signal strength at various points along a traversal path of the autonomous vehicle; and
determination of a portion of a network boundary based upon rate of change in signal strength along the traversal path.
